(19) United States
(12) Patent Application Publication
(10) Pub. No.: US 2026/0119139 A1
(43) Pub. Date: Apr. 30, 2026

(54) METHOD, SYSTEM, AND PRODUCT FOR WATERMARKING

(71) Applicant: Dell Products L.P., Round Rock, TX (US)

(72) Inventors: Yong Lu, Chengdu (CN); Lei Wang, Chengdu (CN); Rongbin Zhang, Chengdu (CN)

(21) Appl. No.: 18/951,169

(22) Filed: Nov. 18, 2024

(30) Foreign Application Priority Data
Oct. 24, 2024 (CN) 202411495748.3

(51) Int. Cl. G06F 8/41

(52) U.S. Cl. CPC G06F 8/41

(57) ABSTRACT

A method in an illustrative embodiment includes obtaining source code and original watermark information, wherein the original watermark information includes source information characterizing the source code. The method further includes obtaining a conversion policy set, wherein the conversion policy set is configured to convert at least a portion of code in the source code, and at least a portion of policies in the conversion policy set can be configured to convert an expression of the source code without changing a logical function of the source code. Additionally, the method includes converting the source code based on the original watermark information and at least a portion of policies in the conversion policy set. The method further includes outputting the converted source code, wherein the source code implicitly contains the original watermark information. Through the method, the security, tamper resistance, and traceability of the source code are improved.

### RELATED APPLICATION

The present application claims priority to Chinese Patent Application No. 202411495748.3, filed Oct. 24, 2024, and entitled “Method, System, and Product for Watermarking,” which is incorporated by reference herein in its entirety.

### FIELD

The present disclosure relates to the technical field of software development, and more specifically, relates to a method, a system, and a computer program product for watermarking.

### BACKGROUND

In today's software industry, it is of great practical value to determine the author of source code. It provides evidence of originality to protect intellectual property rights in copyright disputes. In addition, identifying code developers ensures accountability, and code review is facilitated by confirming whether code is written by a specific individual, team, or AI.

### SUMMARY

In a first aspect of embodiments of the present disclosure, a method for watermarking is provided. The method includes obtaining source code and original watermark information, where the original watermark information includes source information characterizing the source code. The method further includes obtaining a conversion policy set, where the conversion policy set is configured to convert at least a portion of code in the source code, and at least a portion of policies in the conversion policy set can be configured to convert an expression of the source code without changing a logical function of the source code. Additionally, the method includes converting the source code based on the original watermark information and at least a portion of policies in the conversion policy set. Further, the method further includes outputting the converted source code, wherein the source code implicitly contains the original watermark information.

In a second aspect of embodiments of the present disclosure, an electronic device for watermarking is provided. The electronic device comprises at least one processor, and memory coupled to the at least one processor, wherein the memory has instructions stored therein. The instructions, when executed by the at least one processor, cause the electronic device to perform actions for watermarking. The actions include obtaining source code and original watermark information, where the original watermark information includes source information characterizing the source code. The actions further include obtaining a conversion policy set, where the conversion policy set is configured to convert at least a portion of code in the source code, and at least a portion of policies in the conversion policy set can be configured to convert an expression of the source code without changing a logical function of the source code. Additionally, the actions include converting the source code based on the original watermark information and at least a portion of policies in the conversion policy set. The actions further include outputting the converted source code, wherein the source code implicitly contains the original watermark information.

In a third aspect of embodiments of the present disclosure, a computer program product is provided. The computer program product is tangibly stored on a non-transitory computer-readable medium and comprises machine-executable instructions. The machine-executable instructions, when executed by a machine, cause the machine to obtain source code and original watermark information, where the original watermark information includes source information characterizing the source code, to obtain a conversion policy set, where the conversion policy set is configured to convert at least a portion of code in the source code, and at least a portion of policies in the conversion policy set can be configured to convert an expression of the source code without changing a logical function of the source code, to convert the source code based on the original watermark information and at least a portion of policies in the conversion policy set, and to output the converted source code, wherein the source code implicitly contains the original watermark information.

It should be understood that the content described in this Summary is neither intended to limit key or essential features of embodiments of the present disclosure, nor intended to limit the scope of the present disclosure. Other features of the present disclosure will become readily understood from the following description.

### BRIEF DESCRIPTION OF THE DRAWINGS

The above-mentioned and other features, advantages, and aspects of embodiments of the present disclosure will become more apparent with reference to the accompanying drawings and the following Detailed Description. In the accompanying drawings, identical or similar reference numerals represent identical or similar elements, in which:

FIG. 1 shows a flow chart of a method for watermarking according to some embodiments of the present disclosure;

FIG. 2 shows a flow chart of a method for watermarking in which source code is converted according to some embodiments of the present disclosure;

FIG. 3 shows a flow chart of a method for watermarking in which a watermark flag is added according to some embodiments of the present disclosure;

FIG. 4 shows a flow chart of a method for watermarking in which a watermark is extracted according to some embodiments of the present disclosure;

FIG. 5 shows a flow chart of a method for watermarking in which the existence of watermark information is determined according to some other embodiments of the present disclosure;

FIG. 6 shows a flow chart of an overall method for watermarking according to some other embodiments of the present disclosure;

FIG. 7 shows a block diagram of a system for watermarking according to some other embodiments of the present disclosure; and

FIG. 8 shows a block diagram of an electronic device that can implement a plurality of embodiments of the present disclosure.

### DETAILED DESCRIPTION

Illustrative embodiments of the present disclosure will be described in more detail below with reference to the accompanying drawings. Although the accompanying drawings show some embodiments of the present disclosure, it should be understood that the present disclosure can be implemented in various forms, and should not be construed as being limited to the embodiments stated herein. Rather, these embodiments are provided for understanding the present disclosure more thoroughly and completely. It should be understood that the accompanying drawings and embodiments of the present disclosure are for illustrative purposes only, and are not intended to limit the scope of protection of the present disclosure. The embodiments of the present disclosure described below with reference to the accompanying drawings are for illustrative purposes only.

As mentioned above, a considerable amount of code has already been written by artificial intelligence (AI). With the development of the AI technology, it is very important to identify code written by AI and source models thereof. Although AI-generated code improves the development efficiency, it also brings security risks due to the inherent nature of AI. Manual reviews are essential to ensure the quality and security of code. By tracking an AI model that generates code, the model can be evaluated, selected, or improved to ensure the optimum performance and security of the code.

Some researchers use machine learning to detect AI-generated code by means of a method of identifying specific features or fine-tuning models to incorporate detectable features. However, due to the structural nature of the code and the lack of language flexibility, the success rate of these methods is limited. Moreover, AI models need to be trained, which may be difficult, expensive, and inflexible in practice.

In general, a reliable source code watermark must meet some key requirements. Optionally, for example, robustness, that is, the watermark should be resistant to attacks and modifications and still detectable. Optionally, for example, transparency, that is, the watermark does not alter the behavior or performance of an original program. Optionally, for example, security, that is, watermark information can be prevented from being leaked, altered, or deleted. These requirements ensure that the watermark remains valid as evidence.

Some conventional techniques, e.g., embedding information in variable names through naming policies or writing special symbols in code comments, will be easily defeated by an attacker simply renaming variables or deleting comments.

Optionally, some embodiments of the present disclosure provide a code watermark solution that meets the requirements of robustness, transparency, or security. Optionally, some embodiments of the present disclosure use modern language policies and equivalent conversions to hide information in source code. In addition, optionally, some embodiments of the present disclosure introduce error-correcting coding to enhance robustness. Even if an attacker reconstructs source code or modifies all variable names, watermarks can still be detected in some embodiments of the present disclosure. Some embodiments of the present disclosure can be conveniently implemented and are applicable to various code types.

To this end, embodiments of the present disclosure provide a method of adding a secret watermark to source code in order to identify an author. These hidden flags are known only to a creator or authorized users, and can be embedded in data structures, coding styles, comments, or other information that reflects the source and is difficult to detect. Unlike image and audio watermarks, code watermarks require a complex design to ensure that the code watermarks do not affect software performance while remaining accurately identifiable.

Additionally or alternatively, some embodiments of the present disclosure provide a watermark system that can embed and detect specified information in AI-generated or manually developed source code without training or fine-tuning an AI model. The watermark system according to the present disclosure is language-independent, and independent of a coding process, and can be seamlessly integrated into an integrated development environment (IDE), a version control system, or a generative AI (GenAI) platform as a post-processing module, thereby providing extensive adaptability and flexibility.

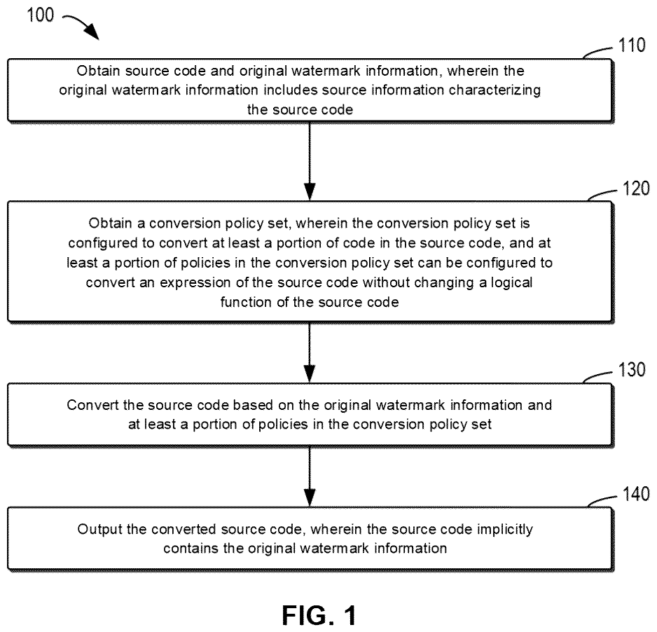

FIG. 1 shows a flow chart of a method 100 for watermarking according to some embodiments of the present disclosure. Individual steps of the method 100 may be performed by a system, apparatus, or computer program product that implements the method. At block 110, source code and original watermark information are obtained, where the original watermark information includes source information characterizing the source code. Optionally, the source information may indicate an author or copyright owner of the source code. Optionally, the source information may further indicate that the source code is generated by AI. Optionally, the source information may be a trade name or trademark information of an enterprise, etc. The present disclosure does not limit the type, concrete content, and size of the source information. Any legal source information suitable for the present disclosure shall fall within the scope of protection of the present disclosure.

At block 120, a conversion policy set is obtained, where the conversion policy set is configured to convert at least a portion of code in the source code, and at least a portion of policies in the conversion policy set can be configured to convert an expression of the source code without changing a logical function of the source code. Optionally, the method 100 further includes preparing the conversion policy set. In general, the conversion policy set needs to be pre-designed according to the syntactic characteristics of different programming languages, and optionally, those skilled in the art can determine different conversion policy sets for different programming languages based on their experiences and through relevant tests.

Optionally, as an example, the conversion policy set T={t1, t2, . . . , tj, . . . t(n−1), tn} includes n policies, where j and n are natural numbers. Optionally, each policy tj is divided into two parts, and the first part is a code conversion description which describes a policy for code conversion. Conversion refers to modifying the code structure within a language syntax policy, e.g., refactoring or formatting. Moreover, conversion cannot change the function of the original code. Optionally, a determination is made by a specific structure in the code. In other words, by detecting the specific structure in the code, it is possible to determine whether the code has been converted.

Optionally, for example, the policy for the code conversion description in the first part may be described as “resort based on the hash values of operands on both sides of an addition operator ‘+,’ and place operands with smaller hash values to the left of an original operation.” Such conversion is determined only by scanning the ‘+’ operator in the code, which does not change the function of the code.

Optionally, each policy tj is divided into two parts, the second part is a target application ratio, i.e., a target ratio of a code structure that conforms to a conversion result after a policy conversion is applied to the code. Optionally, for example, if the ratio is set to 90% and there are 100 addition operators “+” in the code, then after resorting is performed based on the hash values of the operands, 90 instances should conform to the sorting policy and the remaining 10 instances do not conform to the sorting policy, that is, the application ratio of the policy is 90%. Conversely, if there are fewer than 90 structures that conform to a symbolic policy result in the original code, the conversion operation needs to increase the number to 90; if there are more than 90 structures, the number needs to be reduced to 90, so as to satisfy that the target application ratio of the conversion policy is 90%. The flexibility of programming languages enables the present disclosure to easily create tens or even hundreds of code conversion policies. Illustratively, Table 1 summarizes some examples of these conversions, including code refactoring and code formatting. It can be seen that code samples are converted according to code conversion policies 1-6, and the obtained converted code samples have been converted in form, but the relevant converted code samples and the code before converted are equivalent in logic function, and there is no change in logical function between the two. As such, a conversion policy set T including the code conversion policies 1-6 and the like can be configured to convert at least a portion of code in the source code, and at least a portion of policies in the conversion policy set T can be configured to convert an expression of the source code without changing the logical function of the source code. It is noteworthy that Table 1 is an example only and does not limit the scope of protection of the present disclosure. Those skilled in the art can establish corresponding conversion tables for different programming languages according to experiences and actual use situations, as long as the conversion tables are suitable for the present disclosure. Therefore, the conversion tables, similar to Table 1, that are established by those skilled in the art on the basis of their practical experiences should all be within the scope of protection of the present disclosure. It is also noteworthy that although only C++ code is used as an example in the present disclosure, these principles apply equally to other programming languages such as C, JAVA, Python, and so on. The present disclosure does not limit the types of the programming languages, and any suitable programming language should be within the scope of protection of the present disclosure.

TABLE 1

| Serial | Policy | Application | | Converted Code |
|---|---|---|---|---|
| Number | Description | Ratio | Code Sample | Sample |
| 1 | Compare the | 90% | int func(int a, int b) | int func(int a, int b) |
| | hash values of | | { | { |
| | two operands | | int c = a + b; | int c = b + a; |
| | of a ‘+’ | | return c; | return c; |
| | operator, and | | } | } |
| | place the | | // Given Hash(“b”) < | |
| | operand with | | Hash(“a”) | |
| | the smaller | | | |
| | hash value to | | | |
| | the left of the | | | |
| | ‘+’ operator. | | | |
| 2 | Compare the | 60% | bool func(int a, int b, | bool func(int a, int b, int |
| | hash values of | | int n) | n) |
| | two operands | | { | { |
| | of a ‘>‘ or | | return a < n && b < | return a < n && n > b; |
| | ‘<‘ operator, | | n; | } |
| | and place the | | } | |
| | operand with | | // Given Hash(“a”) < | |
| | the smaller | | Hash(“n”) | |
| | hash value to | | // Given Hash(“b”) > | |
| | the left of the | | Hash(“n”) | |
| | ‘>‘ or | | | |
| | ‘<‘ operator. | | | |
| 3 | Compare the | 70% | if(condition){ | if(!condition){ |
| | hash values of | | a = 1; | a = 2; |
| | two code | | } | } |
| | blocks of an | | else{ | else{ |
| | ‘if-else’ | | a = 2; | a = 1; |
| | clause, and | | } | } |
| | place the code | | // Given Hash(“a = | |
| | block with the | | 1”)>Hash(“a = 2”) | |
| | smaller hash | | | |
| | value before | | | |
| | the code block | | | |
| | with the larger | | | |
| | hash value. | | | |
| 4 | Identify a | 40% | switch (cond) | switch (cond) |
| | switch | | { | { |
| | statement | | case 1: | case 2: |
| | which | | std::cout << ‘1’; | std::cout << ‘2’; |
| | contains more | | break; | break; |
| | than 3 case | | case 2: | case 1: |
| | blocks and in | | std::cout << ‘2’; | std::cout << ‘1’; |
| | which the | | break; | break; |
| | total number | | case 3: | case 3: |
| | of the case | | std::cout << ‘3’; | std::cout << ‘3’; |
| | blocks is an | | break; | break; |
| | odd number. | | } | } |
| | If each case | | // Given | |
| | block ends | | Hash(“std::cout << | |
| | with a ‘break’ | | ‘1’; break; “) > | |
| | statement, | | Hash(“std::cout << | |
| | compare the | | ‘3’; break; “) | |
| | hash values of | | // Given | |
| | the case | | Hash(“std::cout << | |
| | blocks, and | | ‘2’; break; “) > | |
| | place the | | Hash(“std::cout << | |
| | block with the | | ‘1’; break; “) | |
| | smaller hash | | | |
| | value before | | | |
| | the block with | | | |
| | the larger | | | |
| | hash value. | | | |
| 5 | Add spaces | 70% | int func(int a, int b, | int func(int a, int b, int |
| | around the | | int c, int d) | c, int d) |
| | operators ‘=,’ | | { | { |
| | ‘*,’ and so on. | | int r=a*b−c+d; | int r = a * b − c + d; |
| | | | return r; | return r; |
| | | | } | } |
| 6 | Add a space | 80% | //This is a c++ | // This is a c++ |
| | between a | | comment | comment |
| | comment | | | |
| | leading out | | | |
| | symbol ‘//’ | | | |
| | and a | | | |
| | comment. | | | |
| 7 | . . . | . . . | . . . | . . . |

Returning to FIG. 1, at block 130, the source code is converted based on the original watermark information and at least a portion of policies in the conversion policy set. Optionally, the method 100 further includes coding the original watermark information to obtain watermark information code. Optionally, the method 100 further includes forming a mapping table from the original watermark information to the watermark information code. Optionally, the method 100 further includes performing error-correcting coding on the watermark information code to obtain error-correcting code of the watermark information code. Optionally, illustratively, the watermark information code and the error-correcting code comprise binary code. As for specifically how to convert the source code based on the original watermark information and at least a portion of policies in the conversion policy set, detailed description will be made in several subsequent embodiments of the present disclosure.

At block 140, the converted source code is output, where the source code implicitly contains the original watermark information. Optionally, since the original watermark information is considered comprehensively when the source code is converted at block 130, the converted source code implicitly contains the original watermark information.

As such, in a plurality of embodiments of the method 100, the source code is converted by taking into account the original watermark information and at least a portion of policies in the conversion policy set, so that the converted source code implicitly contains the original watermark information. In this way, the security, tamper resistance, and traceability of the converted source code are greatly strengthened. Moreover, these implicit flags are known only to a creator or authorized users, and can be embedded in data structures, coding styles, comments, or other information that reflects the source and is difficult to detect, without affecting the software performance while keeping the watermark information accurately identifiable.

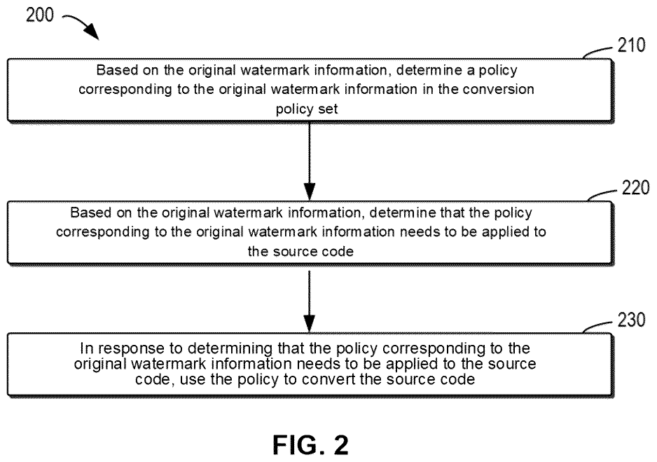

FIG. 2 shows a flow chart of a method 200 for watermarking in which source code is converted according to some embodiments of the present disclosure. The method 200 is configured to convert source code based on original watermark information and a conversion policy set. At block 210, based on that original watermark information, a policy corresponding to the original watermark information in the conversion policy set is determined. Optionally, the determining the policy corresponding to the original watermark information in the conversion policy set may include sorting the conversion policy set. Optionally, for example, the sorting can be performed in order of frequency of use of the operators, and can also be performed in order of hash values of the operators, and the like. Those skilled in the art may select any sorting manners suitable for the present disclosure, which do not limit the scope of protection of the present disclosure. Optionally, the method 200 may further include selecting a top-ranked policy as the policy corresponding to the original watermark information. Optionally, based on the original watermark information, a corresponding top-ranked policy is found as a policy corresponding to the original watermark information to determine whether the policy corresponding to the original watermark information needs to be applied to the source code.

Optionally, as an example, whether each conversion policy in the conversion set is applicable to target source code is analyzed optionally. All applicable conversion policies form an applicable conversion set Tₐ={ta₁, ta₂, . . . , taⱼ, . . . taₙ₋₁, taₙ}, where n and j are natural numbers, taⱼ is the j-th applicable conversion policy, and the total number of the conversion policies in the applicable conversion set is recorded as n. Optionally, the criterion for determining whether a conversion policy is applicable may be whether a corresponding programming language structure is contained in the code. For example, if current source code does not contain the addition operator “+,” then the conversion policy that re-sorts the operands of “+” is not applicable to the current source code and cannot be contained in the applicable conversion set Tₐ.

Optionally, the number of occurrences of a programming language structure corresponding to a policy must reach a preset value, such as at least 200 occurrences, or 500 occurrences, or 1000 occurrences of the addition operator “+,” and so on. It is noteworthy that the preset value is determined by those skilled in the art, and any preset value suitable for the present disclosure should be within the scope of protection of the present disclosure. The reason for setting the minimum number of occurrences is to ensure the robustness of the algorithm. If the number is too small, it may be difficult to meet the application ratio requirements in the policy. For example, if the ratio is set to 90%, while the programming language structure appears only 1-2 times, it is impossible to do anything to achieve this ratio. More importantly, if the number is too small, the tamper resistance of the algorithm will deteriorate. For example, if the ratio is still set to 90% while the programming language structure appears 10 times, then only 9 instances need to be converted to meet the requirements. However, even if an attacker changes only one of them, the ratio will be changed greatly, affecting final watermark extraction.

Optionally, as an example, in some embodiments of the present disclosure, a hash value may be calculated for each conversion policy Tₐ in the applicable conversion set, and then the applicable conversion policies are sorted according to the hash values to obtain a sorted applicable conversion set Tₛ={ts₁, ts₂, . . . , tsⱼ, . . . tsₙ₋₁, tsₙ}. The total number of the conversion policies in the sorted applicable set is recorded as n. tsⱼ is the applicable conversion policy in the applicable conversion set Tₛ. A hash function for calculating hash values may be specified as desired. Since the hash function is secret, an attacker cannot know the sorting scheme. This can prevent watermark counterfeiting, and provide security for the watermark eventually embedded in the source code.

At block 220, it is determined, based on the original watermark information, that the policy corresponding to the original watermark information needs to be applied to the source code. Optionally, as an example, the method 200 further includes performing binary coding on the original watermark information. Those skilled in the art may code the original watermark information using any binary code suitable for the present disclosure, such as ASCII code, which does not limit the scope of protection of the present disclosure. Optionally, the method 200 further includes determining, based on binary code, that the policy corresponding to the original watermark information needs to be applied to the source code. Optionally, according to the binary code of the original watermark information, a digit bit “1” in the binary code indicates that the corresponding conversion policy needs to be applied to the source code, whereas a digit bit “0” in the binary code indicates that the corresponding conversion policy needs not to be applied to the source code. In other words, where the determining that the policy corresponding to the original watermark information needs to be applied to the source code includes, in response to a byte value being 1 in the binary code, determining that the policy corresponding to the original watermark information needs to be applied to the source code, and in response to a byte value being 0 in the binary code, determining that the policy corresponding to the original watermark information needs not to be applied to the source code.

Optionally, as an example, the original watermark information can be represented by binary code W=(w₁, w₂, . . . , wⱼ, . . . wₖ₋₁, wₖ) with a length of k bits, where any bit wⱼ=0 or 1. j and k are natural numbers. Theoretically, the original watermark information can be arbitrarily specified by the developer of the source code. For example, “Dell” can be used as a watermark to indicate that the source code is developed by Dell, and any legal use of the source code should be authorized or licensed by Dell. Optionally, in practice, the length of available information is limited by the size of the applicable conversion set. Accordingly, optionally, a mapping table from short binary sequences to actual information may be established, and the short binary sequence may be used as a watermark embedded in the code. Illustratively, “1010” can replace “Dell,” “1100” can represent “AI Generated Code,” etc.

At block 230, in response to determining that the policy corresponding to the original watermark information needs to be applied to the source code, the policy is used to convert the source code. Optionally, the sorted applicable conversions are applied to the code, thereby embedding the watermark in the source code. Optionally, in some embodiments of the present disclosure, each binary digit of the coded watermark W is matched with a corresponding conversion policy Tₛ in the sorted applicable conversion set. Then, each binary digit of the coded watermark Wis judged one by one. If the binary digit bit W in the coded watermark is “1,” the corresponding conversion policy is applied; if the binary digit bit is “0,” the conversion policy is not applied. In other words, if wⱼ=1, the conversion policy tsⱼ is applied; conversely, if wⱼ=0, the conversion policy tsⱼ is not applied.

As such, in a plurality of embodiments of the method 200, by coding the original watermark information, mapping from the original watermark information to the sorted conversion policy set, and selecting the corresponding applicable policies to convert the source code, the converted source code implicitly contains the original watermark information. In this way, the security, tamper resistance, and traceability of the converted source code are greatly strengthened. Moreover, these implicit flags are known only to a creator or authorized users, and can be embedded in data structures, coding styles, comments, or other information that reflects the source and is difficult to detect, without affecting the software performance while keeping the watermark information accurately identifiable.

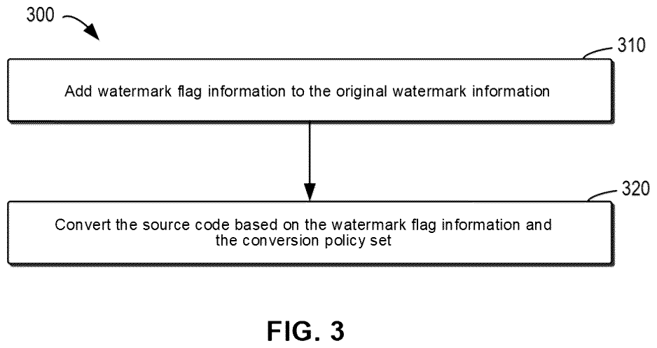

FIG. 3 shows a flow chart of a method 300 for watermarking in which a watermark flag is added according to some embodiments of the present disclosure. The method 300 is used to add watermark flag information to the original watermark information, thereby reducing the calculation of watermark information detection by subsequent detection of the added watermark flag information. At block 310, the watermark flag information is added to the original watermark information. Optionally, the original watermark information may be coded, and optionally, binary coding may be performed on the original watermark information. Those skilled in the art may code the original watermark information using any binary code suitable for the present disclosure, such as ASCII code, which does not limit the scope of protection of the present disclosure. Optionally, as an example, the original watermark information can be represented by binary code W=(w₁, w₂, . . . , wⱼ, . . . wₖ₋₁, wₖ) with a length of k bits, where any bit wⱼ=0 or 1. j and k are natural numbers. Optionally, the method 300 further includes performing error-correcting coding on the watermark information binary code to obtain error-correcting code of the watermark information code W. Optionally, both the watermark information code and the error-correcting code comprise binary code. Optionally, corresponding code of the watermark flag information can be added on the basis of the watermark information code and the error-correcting code, thereby realizing the addition of the watermark flag information to the original watermark information. This will be described in detail in subsequent embodiments of the present disclosure.

Optionally, as an example, an error-correcting code (ECC) algorithm may be selected, and those skilled in the art may select any suitable error-correcting algorithm, which does not limit the scope of protection of the present disclosure. A code word length of the error-correcting code can be set to 1, and the number of correctable errors can be set to e, l and e being natural numbers. The selected error-correcting code must satisfy that an error-correcting code word length is less than the number of conversions in the applicable conversion set Tₛ, i.e., 1<n. In this way, it can be ensured that each piece of converted code can have a corresponding applicable policy; otherwise, there is a problem that the number of policies is not enough. The number of correctable errors e can be determined according to actual needs. An information bit length of the code word is k, which needs to be equal to the length of an original watermark. Illustratively, for error-correcting code of a specified watermark, Bose-Chaudhuri-Hocquenghem (BCH) code may be selected.

As an example, BCH(7, 4, 3) may be used, where Galois field is GF(2³), code word length n=7, information bit length k=4, and error-correcting capability t=1. As an example, for t=1, the generator polynomial g(x) is the minimal polynomial of α. It is assumed that α is a primitive element of GF(2³). The minimal polynomial of α in GF(2³) is 1+x+x³. Therefore, the generator polynomial g(x) of the BCH code is: g(x)=1+x+x³.

As an example, information 1010 can be coded, where 1010 represents the source “Dell” of the source code. The polynomial of 1010 is expressed as u(x)=1+x²+x³. u(x) is multiplied by x^{n-k}, and then divided by g(x) to get a remainder r(x)=x+1. The polynomial of the code word is expressed as c(x)=u(x)·x^{n-k}+r(x)=1+x+x⁴+x⁶. Therefore, the final code word is 1010011. The BCH (7, 4, 3) code can correct at most one error, and thus is suitable for coding information of 4 bits, and the total code word length is 7 bits. Optionally, an original watermark W is processed using a selected error-correcting code algorithm to obtain an error-correcting code watermark Wₑ=(we₁, we₂, . . . , weⱼ, . . . weₗ₋₁, weₗ), the code length of which is l.

Optionally, as an example, in some embodiments of the present disclosure, watermark flag information may be added on the basis of the error-correcting code watermark Wₑ to finally form integrated watermark information. Next, how to form the integrated watermark information will be introduced in detail. Optionally, a binary sequence F=(f₁, f₂, . . . , fⱼ . . . fₙ₋ₗ₋₁, fₙ₋ₗ) may be constructed as watermark flag information of a watermark existence flag to indicate whether a watermark exists, and the length may be n−l, where fⱼ=0 or 1, and n, l, and j are natural numbers. It is possible to design a flag bit where all binary bits are 1, indicating the presence of a watermark. Of course, those skilled in that art may have other suitable designs, e.g., all the binary bits are 0, and particular designs do not constitute a limitation to the scope of protection of the present disclosure. Such design is essentially use of repetition code, which is one type of linear error-correcting code, and can provide a certain tamper-proofing capability. A method for constructing a flag can be designed differently according to specific requirements, which is not limited in the present disclosure. The watermark flag information is used to help determine whether the code is embedded with a watermark before the watermark is extracted. Only when the watermark flag information is detected, will a watermark extraction operation be executed, thus greatly saving the computing resources.

Optionally, in some embodiments of the present disclosure, the error-correcting code watermark Wₑ and the watermark flag information are combined F to form watermark information code with error-correcting and flag bits. Optionally, as an example, a predetermined combination algorithm may be employed to combine the binary sequence of the error-correcting code watermark Wₑ with the binary sequence of the watermark flag information F to obtain an integrated watermark Wₘ=(wm₁, wm₂, . . . , wmⱼ, . . . wmₙ₋₁, wmₙ), where the total length of Wₘ is n, and n is a natural number. Optionally, a combination algorithm can be employed to copy the error-correcting watermark Wₑ as the first l bits of the integrated watermark and to copy the flag F as the last n−l bits of the integrated watermark. Optionally, the integrated watermark can be generated by other methods according to specific needs, and of course, a corresponding algorithm is also required to separate an original code watermark from the flag, thereby ensuring the smooth extraction of the original code watermark. The present disclosure does not limit the specific algorithm of how to integrate watermarks, and those skilled in the art can adopt any suitable algorithm, which is within the scope of protection of the present disclosure.

Returning to FIG. 3, at block 320, the source code is converted based on the watermark flag information and the conversion policy set. Optionally, as described above, since the watermark flag information has been combined with the original watermark information and the error-correcting information to form the integrated watermark information, a corresponding applicable policy is further found Tₛ from the applicable conversion set based on the binary code of the integrated watermark information, and then the corresponding applicable policy is used to convert the source code, thereby implicitly adding the original watermark information to the source code.

As such, in some embodiments of the method 300, by adding the error-correcting information and the watermark flag information on the basis of the original watermark information, the security and tamper resistance of the processed source code are improved. In addition, after the watermark flag information is added, the amount of calculation of extracting the watermark information subsequently is also greatly reduced.

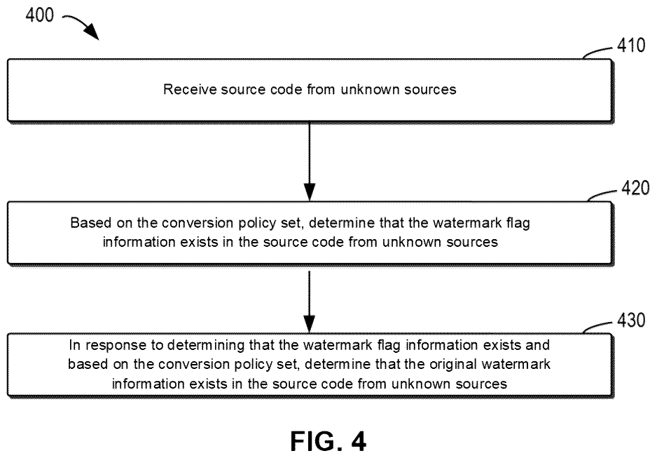

FIG. 4 shows a flow chart of a method 400 for watermarking in which a watermark is extracted according to some embodiments of the present disclosure. The method 400 is used to extract original watermark information from source code to which a watermark has been added according to the present disclosure. At block 410, source code from unknown sources is received. Optionally, there are scenarios where source information of source code from unknown sources needs to be determined, e.g., it is necessary to determine which companies or individuals provide the source code from unknown sources, whether the source code from unknown sources is AI-generated, etc.

At block 420, it is determined that there is watermark flag information in the source code from unknown sources based on a conversion policy set. Optionally, a conversion policy set needs to be selected before the watermark information is extracted. Optionally, in order to detect the existence of a watermark in the source code or to extract a watermark from the source code, it is necessary to select the same conversion set T as when the watermark is embedded and to select an applicable conversion policy from the conversion set T. Optionally, an applicable conversion set Tₐ is obtained using the same method as when the watermark is embedded. Optionally, the applicable conversion policies are sorted. Optionally, the applicable conversion sets can be sorted using the same sorting algorithm and hash function as when the watermark is embedded, resulting in a sorted applicable conversion set Tₛ with a length of n. Optionally, whether a watermark is embedded in target code is detected based on the applicable conversion set Tₛ. Optionally, whether a watermark is embedded in the target code can be detected by checking whether the watermark flag information code exists. Illustratively, the binary code of the detected flag is F_{d}=(fd₁, fd₂, . . . , fdⱼ, . . . fdₙ₋ₗ₋₁, fdₙ₋ₗ). A conversion corresponding to the watermark flag information can be performed. Here, each binary bit of F_{d} corresponds to the last n−l conversions in the sorted applicable conversion set Tₛ, i.e., {tsₗ₊₁, . . . , tsₗ₊ⱼ, . . . tsₙ₋₁, tsₙ}. If different algorithms are used to generate the integrated watermark in the watermark embedding stage, a corresponding inverse algorithm needs to be used to obtain the watermark flag information.

Optionally, the existence of each of the last n−l conversions in the target code may be detected. If the conversions exist, a binary bit corresponding to F_{d} can be set to 1; if the conversions do not exist, it can be set to 0. That is, if tsₗ₊ⱼ exists in the source code, fdⱼ is set to 1; otherwise, fdⱼ is set to 0.

Optionally, determining whether a conversion exists in the code requires calculating whether a code structure conforming to the conversion description satisfies the ratio set in the conversion policy. A tolerance value can be preset when an actual ratio is compared with a desired ratio, and if a difference between the actual ratio and the desired ratio is less than the tolerance value, it is considered that a conversion exists in the code. Setting the tolerance value to 0 means that the actual ratio must be exactly equal to the desired ratio. In some embodiments, for example, the ratio set in the policy is 90%, the actually calculated ratio is 88%, and if the tolerance is set to 3%, then it is determined that the conversion exists; and if the tolerance is set to 1%, it is determined that the conversion does not exist. Those skilled in the art may set a corresponding error tolerance rate based on their experiences or the industry knowledge, and there is no limitation in the present disclosure. Any error tolerance rate suitable for the present disclosure adopted by those skilled in the art is also within the scope of protection of the present disclosure.

Optionally, for flag coding using repetition code, when more than half of the binary bits of F_{d} are 1, it can be determined that a watermark has been embedded in current code; otherwise, it is determined that a watermark is not embedded in the current code, and use of such method can further significantly reduce the amount of calculation for watermark extraction. Optionally, if a flag is not coded using repetition code in the watermark embedding stage, then a corresponding decoding algorithm is required to calculate the value of the flag. If the watermark flag information is detected, it indicates that a watermark is embedded in the source code from unknown sources, and the watermark can be extracted subsequently.

At block 430, in response to determining that the watermark flag information exists, it is determined that the original watermark information exists in the source code from unknown sources based on the conversion policy set. After the existence of the watermark flag information has been determined, it indicates that the source code from unknown sources is embedded with a watermark, so the watermark can be extracted from the source code from unknown sources. In a plurality of subsequent embodiments of the present disclosure, how to determine the existence of the original watermark information in the source code from unknown sources will be further described.

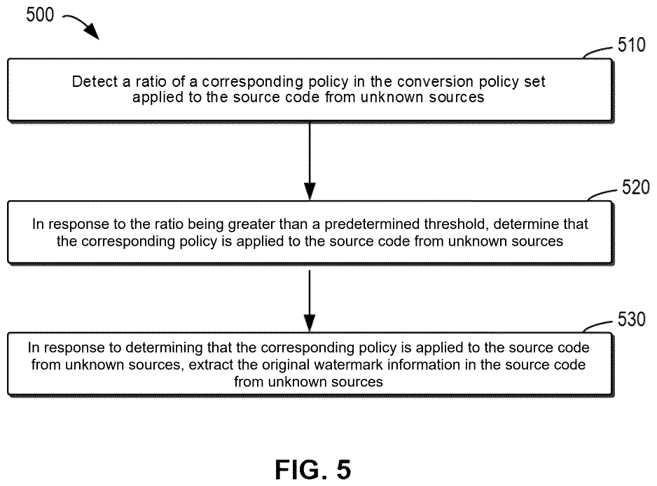

FIG. 5 shows a flow chart of a method 500 for watermarking in which the existence of watermark information is determined according to some other embodiments of the present disclosure. The method 500 may be used to determine whether original watermark information exists in source code from unknown sources and to extract the original watermark information. At block 510, a ratio of a corresponding policy in the conversion policy set applied to the source code from unknown sources is detected. At block 520, in response to the ratio being greater than a predetermined threshold, it is determined that the corresponding policy is applied to the source code from unknown sources. Optionally, the predetermined threshold is determined by those skilled in the art based on their experiences. The predetermined threshold may be 90%, or 70%, etc. The present disclosure is not limited in this regard. Optionally, error-correcting code watermark data needs to be extracted from the source code from unknown sources. In some embodiments of the present disclosure, it is assumed that a binary sequence of an error-correcting code watermark to be extracted is W_{d}=(wd₁, wd₂, . . . , wdⱼ, . . . wdₗ₋₁, wdₗ). A conversion corresponding to the error-correcting code watermark can be further determined. Each binary bit of W_{d} corresponds to one of the first l conversions in a sorted applicable conversion set Tₛ, i.e., {ts₁, . . . , tsⱼ, . . . tsₗ₋₁, tsₗ}. Optionally, if different algorithms are used to generate an integrated watermark in a watermark embedding stage, a corresponding inverse algorithm is needed to obtain a watermark existence flag. The existence of each of the first l conversions in target code is then detected. If a conversion exists, a binary bit corresponding to W=_{da} is set to 1; if it does not exist, it is set to 0.

Optionally, determining whether certain conversion exists in the code requires calculating whether a code structure conforming to the conversion description satisfies the ratio set in the conversion policy. A tolerance value can be preset when an actual ratio is compared with a desired ratio, and if a difference between the actual ratio and the desired ratio is less than the tolerance value, it is considered that the conversion exists in the code. Setting the tolerance value to 0 means that the actual ratio must be exactly equal to the desired ratio. For example, the ratio set in the policy is 90%, the actually calculated ratio is 88%, and if the tolerance is set to 3%, it can be determined that the conversion exists; and if the tolerance is set to 1%, it is determined that the conversion does not exist. Those skilled in the art may set a corresponding error tolerance rate based on their experiences or the industry knowledge, and there is no limitation in the present disclosure. Any error tolerance rate suitable for the present disclosure adopted by those skilled in the art is also within the scope of protection of the present disclosure.

At block 530, in response to determining that the corresponding policy is applied to the source code from unknown sources, the original watermark information in the source code from unknown sources is extracted. Optionally, the extracting the original watermark information in the source code from unknown sources includes decoding the extracted original watermark information using a decoding algorithm, where the decoding algorithm is a decoding algorithm corresponding to a coding algorithm for the original watermark information. Optionally, at least one policy in the conversion policy set is determined based at least on the hash value of an operator expression in the source code.

Optionally, if the source code from unknown sources uses error-correcting code, error-correcting decoding of the watermark data can be extracted based on the error-correcting code algorithm selected in the watermark embedding stage, and the extracted error-correcting watermark data W_{d} obtained in the previous step can be processed using the corresponding error-correcting decoding algorithm. This will result in a decoded watermark

$${W}^{′} = ( {w}_{1}^{{′}^{}} , {w}_{2}^{{′}^{}} , … , {w}_{j}^{{′}^{}} , … {w}_{k - 1}^{{′}^{}} , {w}_{k}^{{′}^{}} ) .$$

Optionally, if the number of error bits in W_{d} is less than a correctable error limit e of the error-correcting code, the decoded watermark code W′ will be the same as an originally embedded watermark W, thereby obtaining the original watermark information W.

As such, in a plurality of embodiments of the method 500, the original watermark information is finally extracted by detecting the ratio of the conversion policy, and the source information of the code from unknown sources is recovered, thereby ensuring that the watermark information can be accurately identified, and greatly improving the practicability and convenience of embodiments of the present disclosure.

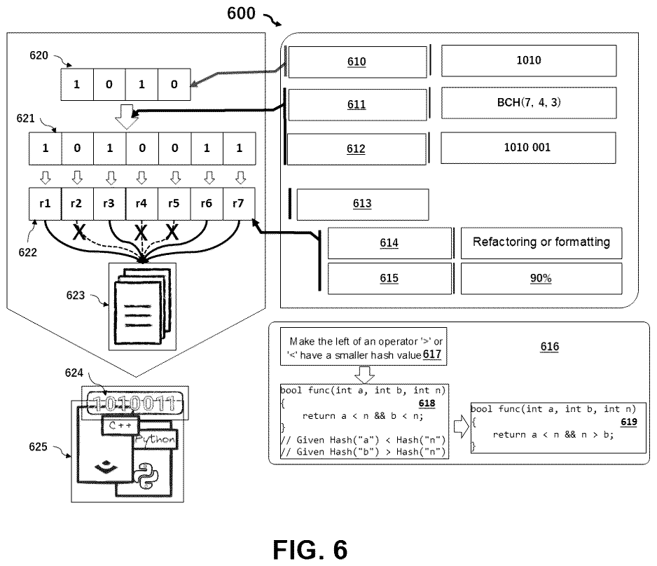

FIG. 6 shows a flow chart of an overall method 600 for watermarking according to some other embodiments of the present disclosure. To assist those skilled in the art in understanding the overall scheme of the present disclosure, the method 600 provides an overall flow chart for watermarking. As an example, at block 610, binary coding is performed on original watermark information “Dell,” 1010001 is used as an example of coding, while the original watermark information “Dell” forms binary code 620 with a value of 1010; and at block 611, an error-correcting algorithm BCH (7, 4, 3) is employed, and finally at block 612 binary error-correcting code 1010011 is formed, as illustrated by code 621. At block 613, a conversion policy set is shown, and the conversion policy set includes a conversion method 614 that includes refactoring or formatting source code, by which only the expression of the source code is changed and the logical function of the source code is not changed. At block 615, an application ratio of the conversion policy set is recorded, for example, 90%. As shown at 622, the conversion policy set shown at block 613 is applied to source code 623 according to the application ratio and the code 621, where the binary bit of the code 621 is “1,” indicating that a corresponding policy needs to be applied to the source code 623, while the binary bit of the code 621 being “0” indicates that a corresponding policy needs not to be applied to the source code 623. Finally, the converted source code 623 is obtained. Block 622 shows that the policies r1, r3, r6, and r7 are applied, and the policies r2, r4, and r5 are not applied to the source code 623 since the binary bit of the code 621 is “0.” Block 616 shows that a piece of source code 618 is converted to code 619 under the action of a conversion policy 617. After the watermark embedding process is performed, converted source code 625 implicitly containing embedded watermark information 624 can be obtained. The source code can be source code written in C++, Python languages, etc. By performing an operation in contrast to the above-mentioned operation on the converted source code 625, the embedded watermark information 624 can be extracted.

The present disclosure further provides an electronic device for watermarking. The electronic device includes a processor and a memory coupled to the processor. The memory has instructions stored therein, and the instructions cause the processor to execute a method for watermarking. The method includes obtaining source code and original watermark information, where the original watermark information includes source information characterizing the source code. The method also obtains a conversion policy set, wherein the conversion policy set is used for converting at least a portion of the code in the source code, and at least a portion of the policies in the conversion policy set can be used for converting the expression of the source code without changing the logical function of the source code. In addition, the method converts the source code based on the original watermark information and at least a portion of policies in the conversion policy set. Further, the method further includes outputting the converted source code, wherein the source code implicitly contains the original watermark information.

In some embodiments, the electronic device is further configured to code the original watermark information to obtain watermark information code, and to form a mapping table from the original watermark information to the watermark information code. The electronic device is further configured to perform error-correcting coding on the watermark information code to obtain error-correcting code of the watermark information code. Optionally, the watermark information code and the error-correcting code comprise binary code.

In some embodiments, the electronic device is further configured to determine a policy corresponding to the original watermark information in the conversion policy set based on the original watermark information; to determine that the policy corresponding to the original watermark information needs to be applied to the source code based on the original watermark information; and to use the policy to convert the source code in response to determining that the policy corresponding to the original watermark information needs to be applied to the source code.

In some embodiments, the electronic device is further configured to perform sorting on the conversion policy set, and to select a top-ranked policy as the policy corresponding to the original watermark information. The electronic device is further configured to perform binary coding on the original watermark information and to determine, based on the binary code, that a policy corresponding to the original watermark information needs to be applied to the source code.

In some embodiments, the electronic device is further configured to determine, in response to a byte value being 1 in the binary code, that the policy corresponding to the original watermark information needs to be applied to the source code, or in response to a byte value being 0 in the binary code, that the policy corresponding to the original watermark information needs not to be applied to the source code.

In some embodiments, the electronic device is further configured to add watermark flag information to the original watermark information, and to convert the source code based on the watermark flag information and the conversion policy set.

In some embodiments, the electronic device is further configured to receive source code from unknown sources, to determine, based on the conversion policy set, that watermark flag information exists in the source code from unknown sources, and to determine, in response to determining that the watermark flag information exists and based on the conversion policy set, that original watermark information exists in the source code from unknown sources. The electronic device is further configured to detect a ratio of a corresponding policy that is in the conversion policy set and applied to the source code from unknown sources, to determine, in response to the ratio being greater than a predetermined threshold, that the corresponding policy is applied to the source code from unknown sources, and to extract the original watermark information in the source code from unknown sources in response to determining that the corresponding policy is applied to the source code from unknown sources.

In some embodiments, the extracting the original watermark information in the source code from unknown sources includes decoding the extracted original watermark information using a decoding algorithm, where the decoding algorithm is a decoding algorithm corresponding to a coding algorithm for the original watermark information. In some embodiments, at least one policy in the conversion policy set is determined based at least on the hash value of an operator expression in the source code.

As such, in a plurality of embodiments of the electronic device, by coding the original watermark information, mapping from the original watermark information to the sorted conversion policy set, and selecting the corresponding applicable policies to convert the source code, the converted source code implicitly contains the original watermark information. In this way, the security, tamper resistance, and traceability of the converted source code are greatly strengthened. Moreover, these implicit flags are known only to a creator or authorized users, and can be embedded in data structures, coding styles, comments, or other information that reflects the source and is difficult to detect, without affecting the software performance while keeping the watermark information accurately identifiable.

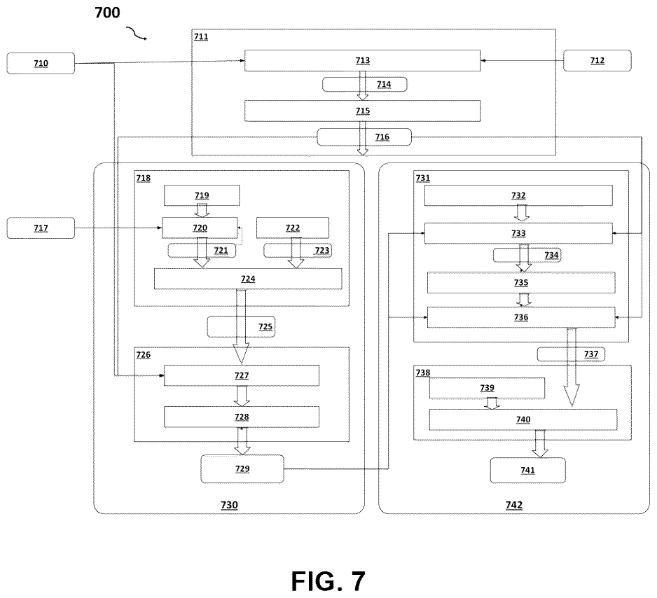

FIG. 7 shows a block diagram of a source code watermark system 700 for watermarking according to some other embodiments of the present disclosure. To assist those skilled in the art in understanding the overall scheme of the present disclosure, the source code watermark system 700 illustrates an example overall structure block diagram for watermarking of source code 710. The source code watermark system 700 comprises a plurality of modules including: a conversion set 712, a watermark coding module 718, a watermark embedding module 726, a watermark extracting module 731, and a watermark decoding module 738. The conversion set 712 may be a set of code conversion policies tailored to a particular programming language. A conversion set processing module 711 selects 713 applicable conversion policies 714 from the conversion set 712, and may re-sort 715 the selected policies to obtain a sorted applicable conversion policy set 716. The watermark coding module 718 may apply a function module 720 of error-correcting code 719 to an original digital watermark 717 to generate an error-correcting code watermark 721, and additionally construct a watermark flag information module 722 to form a watermark flag 723. A watermark integrating module combines 724 the error-correcting code watermark 721 with the watermark flag 723 to form an integrated watermark 725.

The watermark embedding module 726 then selects at 727 an appropriate code conversion policy from the conversion set 712 and applies at 728 the selected appropriate code conversion policy to the source code according to the content of the integrated watermark 725, thereby completing embedding the integrated watermark 725 in the code, resulting in watermarked code 729. Block 730 shows the overall processing procedure of watermark embedding in some embodiments. The watermark extracting module 731 detects whether given code contains a digital watermark added by the system. If a watermark is found, the digital watermark is extracted. In the watermark extracting module 731, at block 732, it is determined that a watermark flag exists in the code, and then at block 733, the watermark flag is detected in the code and the watermark flag 734 is obtained. An embedded watermark existing in the converted code is determined at block 735, and an error-correcting code watermark 737 is obtained by detecting the watermark in the code at block 736. The watermark decoding module 738 performs error-correcting decoding on the extracted digital watermark, where the same error-correcting code algorithm is selected at block 739, and error-correcting decoding is performed at block 740 to finally obtain an original watermark 741, such as “Dell.” Block 742 shows the overall processing procedure of watermark detecting in some embodiments. The source code watermark system 700 has two main functions, one is to embed specified watermark information in specific code, and the other one is to detect and extract the watermark information from the specific code.

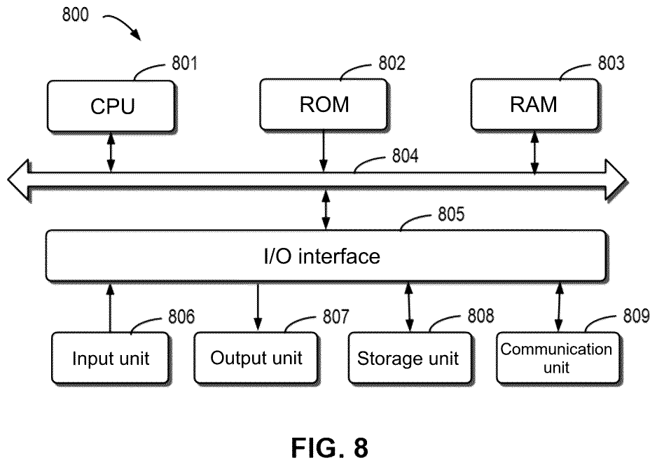

FIG. 8 shows a block diagram of an electronic device 800 that can implement a plurality of embodiments of the present disclosure. As shown in the figure, the device 800 includes at least one central processing unit (CPU) 801 that may execute various appropriate actions and processing according to computer program instructions stored in a read-only memory (ROM) 802 or computer program instructions loaded from a storage unit 808 to a random access memory (RAM) 803. Various programs and data required for the operation of the device 800 may also be stored in the RAM 803. The CPU 801, the ROM 802, and the RAM 803 are connected to each other through a bus 804. An input/output (I/O) interface 805 is also connected to the bus 804.

A plurality of components in the device 800 are connected to the I/O interface 805, including: an input unit 806 such as a keyboard and a mouse; an output unit 807, such as various types of displays and speakers; a storage unit 808, such as a magnetic disk and an optical disc; and a communication unit 809, such as a network card, a modem, and a wireless communication transceiver. The communication unit 809 allows the device 800 to exchange information/data with other devices via a computer network, such as the Internet, and/or various telecommunication networks.

The various methods and processes described above, such as the methods 100 and 300, may be performed by the CPU 801. For example, in some embodiments, the methods 100 and 300 may be implemented as a computer software program that is tangibly included in a machine-readable medium, such as the storage unit 808. In some embodiments, part or all of the computer program may be loaded and/or installed onto the device 800 via the ROM 802 and/or the communication unit 809. When the computer program is loaded into the RAM 803 and executed by the CPU 801, one or more actions of the methods 100 and 300 described above may be implemented.

Embodiments of the present disclosure include a method, an apparatus, a device (system), a vehicle, and/or a computer program product. The computer program product may include a computer-readable storage medium with computer-readable program instructions for executing various aspects of the present disclosure loaded thereon.

The computer-readable storage medium may be a tangible device that may hold and store instructions used by an instruction-executing device. For example, the computer-readable storage medium may be, but is not limited to, an electric storage device, a magnetic storage device, an optical storage device, an electromagnetic storage device, a semiconductor storage device, or any suitable combination of the foregoing. More specific examples (a non-exhaustive list) of the computer-readable storage medium include: a portable computer disk, a hard disk, a RAM, a ROM, an erasable programmable read-only memory (EPROM or flash memory), a static random access memory (SRAM), a portable compact disc read-only memory (CD-ROM), a digital versatile disc (DVD), a memory stick, a floppy disk, a mechanical encoding device, for example, a punch card or a raised structure in a groove with instructions stored thereon, and any appropriate combination of the foregoing. The computer-readable storage medium used herein is not to be interpreted as transient signals per se, such as radio waves or other freely propagating electromagnetic waves, electromagnetic waves propagating through waveguides or other transmission media (e.g., light pulses through fiber-optic cables), or electrical signals transmitted through electrical wires.

The computer-readable program instructions described herein may be downloaded from a computer-readable storage medium to various computing/processing devices or downloaded to an external computer or external storage device via a network, such as the Internet, a local area network, a wide area network, and/or a wireless network. The network may include copper transmission cables, fiber optic transmission, wireless transmission, routers, firewalls, switches, gateway computers, and/or edge servers. A network adapter card or network interface in each computing/processing device receives computer-readable program instructions from the network and forwards the computer-readable program instructions for storage in a computer-readable storage medium in each computing/processing device.

The computer program instructions for executing the operation of the present disclosure may be assembly instructions, instruction set architecture (ISA) instructions, machine instructions, machine-dependent instructions, microcode, firmware instructions, status setting data, or source code or object code written in any combination of one or more programming languages, the programming languages including object-oriented programming languages such as Smalltalk, C++, or the like, and conventional procedural programming languages such as the C language or similar programming languages. The computer-readable program instructions may be executed entirely on a user's computer, partly on a user's computer, as a stand-alone software package, partly on a user's computer and partly on a remote computer, or entirely on a remote computer or a server. In a case where a remote computer is involved, the remote computer can be connected to a user computer through any kind of networks, including a local area network (LAN) or a wide area network (WAN), or can be connected to an external computer (for example, connected through the Internet using an Internet service provider). In some embodiments, an electronic circuit, such as a programmable logic circuit, a field programmable gate array (FPGA), or a programmable logic array (PLA), is customized by utilizing status information of the computer-readable program instructions. The electronic circuit may execute the computer-readable program instructions to implement various aspects of the present disclosure.

Various aspects of the present disclosure are described herein with reference to flow charts and/or block diagrams of the method, the apparatus (system), and the computer program product implemented according to embodiments of the present disclosure. It should be understood that each block of the flow charts and/or block diagrams and combinations of blocks in the flow charts and/or block diagrams may be implemented by computer-readable program instructions.

These computer-readable program instructions may be provided to a processing unit of a general-purpose computer, a special-purpose computer, or a further programmable data processing apparatus, thereby producing a machine, such that these instructions, when executed by the processing unit of the computer or the further programmable data processing apparatus, produce means for implementing functions/actions specified in one or more blocks in the flow charts and/or block diagrams. These computer-readable program instructions may also be stored in a computer-readable storage medium, and these instructions cause a computer, a programmable data processing apparatus, and/or other devices to operate in a specific manner; and thus the computer-readable medium having instructions stored includes an article of manufacture that includes instructions that implement various aspects of the functions/actions specified in one or more blocks in the flow charts and/or block diagrams.

The computer-readable program instructions may also be loaded to a computer, a further programmable data processing apparatus, or a further device, so that a series of operating steps may be performed on the computer, the further programmable data processing apparatus, or the further device to produce a computer-implemented process, such that the instructions executed on the computer, the further programmable data processing apparatus, or the further device may implement the functions/actions specified in one or more blocks in the flow charts and/or block diagrams.

The flow charts and block diagrams in the drawings illustrate the architectures, functions, and operations of possible implementations of the systems, methods, and computer program products according to various embodiments of the present disclosure. In this regard, each block in the flow charts or block diagrams may represent a module, a program segment, or part of an instruction, the module, program segment, or part of an instruction including one or more executable instructions for implementing specified logical functions. In some alternative implementations, functions marked in the blocks may also occur in an order different from that marked in the accompanying drawings. For example, two successive blocks may actually be executed in parallel substantially, and sometimes they may also be executed in an inverse order, which depends on the functions involved. It should be further noted that each block in the block diagrams and/or flow charts as well as a combination of blocks in the block diagrams and/or flow charts may be implemented using a special hardware-based system that executes specified functions or actions, or using a combination of special hardware and computer instructions.

Various embodiments of the present disclosure have been described above. The foregoing description is illustrative rather than exhaustive, and is not limited to the disclosed embodiments. Numerous modifications and alterations will be apparent to persons of ordinary skill in the art without departing from the scope and spirit of the illustrated embodiments. The selection of terms used herein is intended to best explain the principles and practical applications of the various embodiments and their associated technological improvements, so as to enable persons of ordinary skill in the art to understand the embodiments disclosed herein.

What is claimed is:

1. A method for watermarking, comprising:
obtaining source code and original watermark information, wherein the original watermark information includes source information characterizing the source code;
obtaining a conversion policy set, wherein the conversion policy set is configured to convert at least a portion of code in the source code, and at least a portion of policies in the conversion policy set can be configured to convert an expression of the source code without changing a logical function of the source code;
converting the source code based on the original watermark information and at least a portion of policies in the conversion policy set; and
outputting the converted source code, wherein the source code implicitly contains the original watermark information.

2. The method according to claim 1, further comprising:
coding the original watermark information to obtain watermark information code; and
forming a mapping table from the original watermark information to the watermark information code.

3. The method according to claim 2, further comprising:
performing error-correcting coding on the watermark information code to obtain error-correcting code of the watermark information code.

4. The method according to claim 3, wherein the watermark information code and the error-correcting code comprise binary code.

5. The method according to claim 1, wherein the converting the source code comprises:
based on the original watermark information, determining a policy corresponding to the original watermark information in the conversion policy set;
based on the original watermark information, determining that the policy corresponding to the original watermark information needs to be applied to the source code; and
in response to determining that the policy corresponding to the original watermark information needs to be applied to the source code, using the policy to convert the source code.

6. The method according to claim 5, wherein the determining the policy corresponding to the original watermark information in the conversion policy set comprises:
sorting the conversion policy set; and
selecting a top-ranked policy as the policy corresponding to the original watermark information.

7. The method according to claim 5, wherein the determining that the policy corresponding to the original watermark information needs to be applied to the source code comprises:
performing binary coding on the original watermark information to obtain binary code; and
based on the binary code, determining that the policy corresponding to the original watermark information needs to be applied to the source code.

8. The method according to claim 7, wherein the determining that the policy corresponding to the original watermark information needs to be applied to the source code further comprises:
in response to a byte value being 1 in the binary code, determining that the policy corresponding to the original watermark information needs to be applied to the source code; alternatively,
in response to a byte value being 0 in the binary code, determining that the policy corresponding to the original watermark information needs not to be applied to the source code.

9. The method according to claim 1, further comprising:
adding watermark flag information to the original watermark information.

10. The method according to claim 9, further comprising:
converting the source code based on the watermark flag information and the conversion policy set.

11. The method according to claim 10, further comprising:
receiving source code from unknown sources;
based on the conversion policy set, determining that the watermark flag information exists in the source code from unknown sources; and
in response to determining that the watermark flag information exists and based on the conversion policy set, determining that the original watermark information exists in the source code from unknown sources.

12. The method according to claim 11, wherein the determining that the original watermark information exists in the source code from unknown sources comprises:
detecting a ratio of a corresponding policy in the conversion policy set applied to the source code from unknown sources;
in response to the ratio being greater than a predetermined threshold, determining that the corresponding policy is applied to the source code from unknown sources; and
in response to determining that the corresponding policy is applied to the source code from unknown sources, extracting the original watermark information in the source code from unknown sources.

13. The method according to claim 12, wherein the extracting the original watermark information in the source code from unknown sources comprises decoding the extracted original watermark information using a decoding algorithm, wherein the decoding algorithm is a decoding algorithm corresponding to a coding algorithm for the original watermark information.

14. The method according to claim 1, wherein at least one policy in the conversion policy set is determined based at least on a hash value of an operator expression in the source code.

15. An electronic device for watermarking, comprising:
at least one processor; and
memory coupled to the at least one processor, wherein the memory has instructions stored therein, and the instructions, when executed by the at least one processor, cause the electronic device to perform actions comprising:
obtaining source code and original watermark information, wherein the original watermark information includes source information characterizing the source code;
obtaining a conversion policy set, wherein the conversion policy set is configured to convert at least a portion of code in the source code, and at least a portion of policies in the conversion policy set can be configured to convert an expression of the source code without changing a logical function of the source code;
converting the source code based on the original watermark information and at least a portion of policies in the conversion policy set; and
outputting the converted source code, wherein the source code implicitly contains the original watermark information.

16. The electronic device according to claim 15, wherein the converting the source code comprises:
based on the original watermark information, determining a policy corresponding to the original watermark information in the conversion policy set;
based on the original watermark information, determining that the policy corresponding to the original watermark information needs to be applied to the source code; and
in response to determining that the policy corresponding to the original watermark information needs to be applied to the source code, using the policy to convert the source code.

17. The electronic device according to claim 16, wherein the determining the policy corresponding to the original watermark information in the conversion policy set comprises:
sorting the conversion policy set; and
selecting a top-ranked policy as the policy corresponding to the original watermark information.

18. The electronic device according to claim 16, wherein the determining that the policy corresponding to the original watermark information needs to be applied to the source code comprises:
performing binary coding on the original watermark information to obtain binary code; and
based on the binary code, determining that the policy corresponding to the original watermark information needs to be applied to the source code.

19. The electronic device according to claim 18, wherein the determining that the policy corresponding to the original watermark information needs to be applied to the source code further comprises:
in response to a byte value being 1 in the binary code, determining that the policy corresponding to the original watermark information needs to be applied to the source code; alternatively,
in response to a byte value being 0 in the binary code, determining that the policy corresponding to the original watermark information needs not to be applied to the source code.

20. A computer program product tangibly stored on a non-transitory computer-readable medium and comprising machine-executable instructions, wherein the machine-executable instructions, when executed by a machine, cause the machine to:
obtain source code and original watermark information, wherein the original watermark information includes source information characterizing the source code;
obtain a conversion policy set, wherein the conversion policy set is configured to convert at least a portion of code in the source code, and at least a portion of policies in the conversion policy set can be configured to convert an expression of the source code without changing a logical function of the source code;
convert the source code based on the original watermark information and at least a portion of policies in the conversion policy set; and
output the converted source code, wherein the source code implicitly contains the original watermark information.
